(19) United States
(12) Patent Application Publication
(10) Pub. No.: US 2007/0258459 A1
(43) Pub. Date: Nov. 8, 2007

(54) Method and system for QOS by proxy

(75) Inventors: Donald L. Smith, Satellite Beach, FL (US); Anthony P. Gallusclo, Indialantic, FL (US); Robert J. Knazik, Cocoa Beach, FL (US)

Correspondence Address: MCANDREWS HELD & MALLOY, LTD, 500 WEST MADISON STREET, SUITE 3400, CHICAGO, IL, 60661, US

(73) Assignee: Harris Corporation

(21) Appl. No.: 11/416,043

(22) Filed: May 2, 2006

(51) Int. Cl. H04L 12/56

(52) U.S. Cl. 370/395.2; 370/412

(57) ABSTRACT

The presently described technology provides a method for selectively applying one or more QoS algorithms. The method comprises receiving data transmitted to a destination node in one or more of a first network and a second network and applying at least one of the QoS algorithms to the data based on the intended destination of the data. The presently described technology also provides a computer-readable storage medium comprising a set of instructions for a computer. The set of instructions comprises a data destination routine and an application routine. The data destination routine is configured to determine an intended destination of data received at a routing node. The application routine is configured to apply at least one QoS algorithm to at least a subset of the data based on the intended destination of the data.

### BACKGROUND

The presently described technology generally relates to communications networks. More particularly, the presently described technology relates to systems and methods for protocol filtering for Quality of Service.

Communications networks are utilized in a variety of environments. Communications networks typically include two or more nodes connected by one or more links. Generally, a communications network is used to support communication between two or more participant nodes over the links and intermediate nodes in the communications network. There may be many kinds of nodes in the network. For example, a network may include nodes such as clients, servers, workstations, switches, and/or routers. Links may be, for example, modem connections over phone lines, wires, Ethernet links, Asynchronous Transfer Mode (“ATM”) circuits, satellite links, and/or fiber optic cables.

A communications network may actually be composed of one or more smaller communications networks. For example, the Internet is often described as network of interconnected computer networks. Each network may utilize a different architecture and/or topology. For example, one network may be a switched Ethernet network with a star topology and another network may be a Fiber-Distributed Data Interface (“FDDI”) ring.

Communications networks may carry a wide variety of data. For example, a network may carry bulk file transfers alongside data for interactive real-time conversations. The data sent on a network is often sent in packets, cells, or frames. Alternatively, data may be sent as a stream. In some instances, a stream or flow of data may actually be a sequence of packets. Networks such as the Internet provide general purpose data paths between a range of nodes and carrying a vast array of data with different requirements.

Communication over a network typically involves multiple levels of communication protocols. A protocol stack, also referred to as a networking stack or protocol suite, refers to a collection of protocols used for communication. Each protocol may be focused on a particular type of capability or form of communication. For example, one protocol may be concerned with the electrical signals needed to communicate with devices connected by a copper wire. Other protocols may address ordering and reliable transmission between two nodes separated by many intermediate nodes, for example.

Protocols in a protocol stack typically exist in a hierarchy. Often, protocols are classified into layers. One reference model for protocol layers is the Open Systems Interconnection (“OSI”) model. The OSI reference model includes seven layers: a physical layer, data link layer, network layer, transport layer, session layer, presentation layer, and application layer. The physical layer is the “lowest” layer, while the application layer is the “highest” layer. Two well-known transport layer protocols are the Transmission Control Protocol (“TCP”) and User Datagram Protocol (“UDP”). A well known network layer protocol is the Internet Protocol (“IP”).

At the transmitting node, data to be transmitted is passed down the layers of the protocol stack, from highest to lowest. Conversely, at the receiving node, the data is passed up the layers, from lowest to highest. At each layer, the data may be manipulated by the protocol handling communication at that layer. For example, a transport layer protocol may add a header to the data that allows for ordering of packets upon arrival at a destination node. Depending on the application, some layers may not be used, or even present, and data may just be passed through.

One kind of communications network is a tactical data network. A tactical data network may also be referred to as a tactical communications network. A tactical data network may be utilized by units within an organization such as a military (for example, army, navy, and/or air force). Nodes within a tactical data network may include, for example, individual soldiers, aircraft, command units, satellites, and/or radios. A tactical data network may be used for communicating data such as voice, position telemetry, sensor data, and/or real-time video.

An example of how a tactical data network may be employed is as follows. A logistics convoy may be in-route to provide supplies for a combat unit in the field. Both the convoy and the combat unit may be providing position telemetry to a command post over satellite radio links. An unmanned aerial vehicle (“UAV”) may be patrolling along the road the convoy is taking and transmitting real-time video data to the command post over a satellite radio link also. At the command post, an analyst may be examining the video data while a controller is tasking the UAV to provide video for a specific section of road. The analyst may then spot an improvised explosive device (“IED”) that the convoy is approaching and send out an order over a direct radio link to the convoy for it to halt and alerting the convoy to the presence of the IED.

The various networks that may exist within a tactical data network may have many different architectures and characteristics. For example, a network in a command unit may include a gigabit Ethernet local area network (“LAN”) along with radio links to satellites and field units that operate with much lower throughput and higher latency. Field units may communicate both via satellite and via direct path radio frequency (“RF”). Data may be sent point-to-point, multicast, or broadcast, depending on the nature of the data and/or the specific physical characteristics of the network. A network may include radios, for example, set up to relay data. In addition, a network may include a high frequency (“HF”) network which allows long rang communication. A microwave network may also be used, for example. Due to the diversity of the types of links and nodes, among other reasons, tactical networks often have overly complex network addressing schemes and routing tables. In addition, some networks, such as radio-based networks, may operate using bursts. That is, rather than continuously transmitting data, they send periodic bursts of data. This is useful because the radios are broadcasting on a particular channel that must be shared by all participants, and only one radio may transmit at a time.

Tactical data networks are generally bandwidth-constrained. That is, there is typically more data to be communicated than bandwidth available at any given point in time. These constraints may be due to either the demand for bandwidth exceeding the supply, and/or the available communications technology not supplying enough bandwidth to meet the user's needs, for example. For example, between some nodes, bandwidth may be on the order of kilobits/sec. In bandwidth-constrained tactical data networks, less important data can clog the network, preventing more important data from getting through in a timely fashion, or even arriving at a receiving node at all. In addition, portions of the networks may include internal buffering to compensate for unreliable links. This may cause additional delays. Further, when the buffers get full, data may be dropped.

In many instances the bandwidth available to a network cannot be increased. For example, the bandwidth available over a satellite communications link may be fixed and cannot effectively be increased without deploying another satellite. In these situations, bandwidth must be managed rather than simply expanded to handle demand. In large systems, network bandwidth is a critical resource. It is desirable for applications to utilize bandwidth as efficiently as possible. In addition, it is desirable that applications avoid “clogging the pipe,” that is, overwhelming links with data, when bandwidth is limited. When bandwidth allocation changes, applications should preferably react. Bandwidth can change dynamically due to, for example, quality of service, jamming, signal obstruction, priority reallocation, and line-of-sight. Networks can be highly volatile and available bandwidth can change dramatically and without notice.

In addition to bandwidth constraints, tactical data networks may experience high latency. For example, a network involving communication over a satellite link may incur latency on the order of half a second or more. For some communications this may not be a problem, but for others, such as real-time, interactive communication (for example, voice communications) for example, it is highly desirable to minimize latency as much as possible.

Another characteristic common to many tactical data networks is data loss. Data may be lost due to a variety of reasons. For example, a node with data to send may be damaged or destroyed. As another example, a destination node may temporarily drop off of the network. This may occur because, for example, the node has moved out of range, the communication's link is obstructed, and/or the node is being jammed. Data may be lost because the destination node is not able to receive it and intermediate nodes lack sufficient capacity to buffer the data until the destination node becomes available. Additionally, intermediate nodes may not buffer the data at all, instead leaving it to the sending node to determine if the data ever actually arrived at the destination.

Often, applications in a tactical data network are unaware of and/or do not account for the particular characteristics of the network. For example, an application may simply assume it has as much bandwidth available to it as it needs. As another example, an application may assume that data will not be lost in the network. Applications which do not take into consideration the specific characteristics of the underlying communications network may behave in ways that actually exacerbate problems. For example, an application may continuously send a stream of data that could just as effectively be sent less frequently in larger bundles. The continuous stream may incur much greater overhead in, for example, a broadcast radio network that effectively starves other nodes from communicating, whereas less frequent bursts would allow the shared bandwidth to be used more effectively.

Certain protocols do not work well over tactical data networks. For example, a protocol such as TCP may not function well over a radio-based tactical network because of the high loss rates and latency such a network may encounter. TCP requires several forms of handshaking and acknowledgments to occur in order to send data. High latency and loss may result in TCP hitting time outs and not being able to send much, if any, meaningful data over such a network.

Information communicated with a tactical data network often has various levels of priority with respect to other data in the network. For example, threat warning receivers in an aircraft may have higher priority than position telemetry information for troops on the ground miles away. As another example, orders from headquarters regarding engagement may have higher priority than logistical communications behind friendly lines. The priority level may depend on the particular situation of the sender and/or receiver. For example, position telemetry data may be of much higher priority when a unit is actively engaged in combat as compared to when the unit is merely following a standard patrol route. Similarly, real-time video data from a UAV may have higher priority when it is over the target area as opposed to when it is merely in-route.

There are several approaches to delivering data over a network. One approach, used by many communications networks, is a “best effort” approach. That is, data being communicated will be handled as well as the network can, given other demands, with regard to capacity, latency, reliability, ordering, and errors. Thus, the network provides no guarantees that any given piece of data will reach its destination in a timely manner, or at all. Additionally, no guarantees are made that data will arrive in the order sent or even without transmission errors changing one or more bits in the data.

Another approach is Quality of Service (“QoS”). QoS refers to one or more capabilities of a network to provide various forms of guarantees with regard to data that is carried. For example, a network supporting QoS may guarantee a certain amount of bandwidth to a data stream. As another example, a network may guarantee that packets between two particular nodes have some maximum latency. Such a guarantee may be useful in the case of a voice communication where the two nodes are two people having a conversation over the network. Delays in data delivery in such a case may result in irritating gaps in communication and/or dead silence, for example.

QoS may be viewed as the capability of a network to provide better service to selected network traffic. The primary goal of QoS is to provide priority including dedicated bandwidth, controlled jitter and latency (required by some real-time and interactive traffic), and improved loss characteristics. Another important goal is making sure that providing priority for one flow does not make other flows fail. That is, guarantees made for subsequent flows must not break the guarantees made to existing flows.

Current approaches to QoS often require every node in a network to support QoS, or, at the very least, for every node in the network involved in a particular communication to support QoS. For example, in current systems, in order to provide a latency guarantee between two nodes, every node carrying the traffic between those two nodes must be aware of and agree to honor, and be capable of honoring, the guarantee.

There are several approaches to providing QoS or QoS parameter/mechanisms/algorithms. One approach is Integrated Services, or “IntServ.” IntServ provides a QoS system wherein every node in the network supports the services and those services are reserved when a connection is set up. IntServ does not scale well because of the large amount of state information that must be maintained at every node and the overhead associated with setting up such connections.

Another approach to providing QoS is Differentiated Services, or “DiffServ.” DiffServ is a class of service model that enhances the best-effort services of a network such as the Internet. DiffServ differentiates traffic by user, service requirements, and other criteria. Then, DiffServ marks packets so that network nodes can provide different levels of service via priority queuing or bandwidth allocation, or by choosing dedicated routes for specific traffic flows. Typically, a node has a variety of queues for each class of service. The node then selects the next packet to send from those queues based on the class categories.

Existing QoS solutions are often network specific and each network type or architecture may require a different QoS configuration. Due to the mechanisms existing QoS solutions utilize, messages that look the same to current QoS systems may actually have different priorities based on message content. However, data consumers may require access to high-priority data without being flooded by lower-priority data. Existing QoS systems cannot provide QoS based on message content at the transport layer.

As mentioned, existing QoS solutions require at least the nodes involved in a particular communication to support QoS. However, the nodes at the “edge” of network may be adapted to provide some improvement in QoS, even if they are incapable of making total guarantees. Nodes are considered to be at the edge of the network if they are the participating nodes in a communication (that is, the transmitting and/or receiving nodes) and/or if they are located at chokepoints in the network. A chokepoint is a section of the network where all traffic must pass to another portion. For example, a router or gateway from a LAN to a satellite link would be a choke point, since all traffic from the LAN to any nodes not on the LAN must pass through the gateway to the satellite link.

Thus, there is a need for systems and methods providing QoS in a tactical data network. There is a need for systems and methods for providing QoS on the edge of a tactical data network. Additionally, there is a need for adaptive, configurable QoS systems and methods in a tactical data network.

In addition, in some network environments (including, for example, military tactical networks), data can be streaming at a high rate from a large bandwidth network and routed to other large bandwidth and small bandwidth networks. For example, large amounts of data may be transmitted at a high rate from a network capable of transmitting data at a throughput of 500 kilobytes per second (“kbps”) or more (for example, an Enhanced Position Location Reporting System (“EPLRS”) network or an Ethernet network). This data may be routed to a network incapable of transmitting data at as high of a rate as a high bandwidth network. For example, such a network can include a wireless network, a tactical satellite network, or a high frequency network. In addition, external factors such as geographic obstacles (that is, mountainous terrain for example) may impede the flow of data in lower bandwidth networks. Such external factors may be prevalent in military tactical networks in the field. The high rate and volume of data routed to the lower bandwidth networks can overrun the network. For example, destination nodes on the smaller or lower bandwidth network may not be capable of handling the large amounts of data transmitted to the nodes.

In such a scenario, data of increased priority or importance may be overrun by data of lesser priority or importance. For example, large amounts of audio and video data can overrun higher priority positional data transmitted to soldiers in the field. The audio and video data can then prevent the positional data from being received in time to warn soldiers in the field of an IED or enemy soldiers in the area.

One solution to this problem is to selectively apply QoS parameters/algorithms/mechanisms to data intended or destined for destination nodes in the lower or smaller bandwidth networks. By applying the QoS algorithms only to data destined for such networks, timely delivery of higher priority data can be ensured at nodes in the lower bandwidth networks. Thus, a need exists for systems and methods for selectively providing QoS to data bound for lower bandwidth networks. Such a need can be met by selectively applying, at a routing node, QoS parameters/algorithms/mechanisms to data destined for a node in a lower bandwidth network.

### SUMMARY OF THE INVENTION

The presently described technology provides a method for selectively applying one or more QoS algorithms. The method comprises receiving data transmitted to a node at a predetermined destination in at least one of a first network and a second network and applying at least one of the QoS algorithms to the data based on the destination.

The presently described technology also provides a computer-readable storage medium comprising a set of instructions for a computer. The set of instructions comprises a data destination routine and an application routine. The data destination routine is configured to determine an intended destination of data received at a routing node. The application routine is configured to apply at least one QoS algorithm to at least a subset of the data where the algorithm is based on the destination.

The presently described technology also provides a method for applying a QoS algorithm to a network by proxy. The method comprises receiving data at a routing node, determining an intended destination of a first data subset in a high speed network and an intended destination of a second data subset in a low speed network, routing the first data subset to its intended destination in the high speed network without applying the QoS algorithm to the first data subset, applying the QoS algorithm to the second data subset, and routing the second data subset to its intended destination of the second data subset in the low speed network.

### BRIEF DESCRIPTION OF SEVERAL VIEWS OF THE DRAWINGS

FIG. 1 illustrates a tactical communications network environment operating with an embodiment of the presently described technology.

FIG. 2 illustrates a schematic diagram of the OSI seven-layer model and the operation of the set of instructions for computing device in accordance with an embodiment of the presently described technology.

FIG. 3 illustrates an example of multiple networks facilitated using the data communications system in accordance with an embodiment of the presently described technology.

FIG. 4 illustrates a system for selectively applying QoS algorithms by proxy to data transmitted to a network in accordance with an embodiment of the presently described technology.

FIG. 5 illustrates a flowchart of a method for selectively applying QoS algorithms by proxy to data transmitted to a network in accordance with an embodiment of the presently described technology.

FIG. 6 illustrates a flowchart of method for selectively applying QoS algorithms by proxy to data transmitted from one high speed network to another in accordance with an embodiment of the presently described technology.

The foregoing summary, as well as the following detailed description of certain embodiments of the presently described technology, will be better understood when read in conjunction with the appended drawings. For the purpose of illustrating the presently described technology, certain embodiments are shown in the drawings. It should be understood, however, that the presently described technology is not limited to the arrangements and instrumentality shown in the attached drawings.

### DETAILED DESCRIPTION

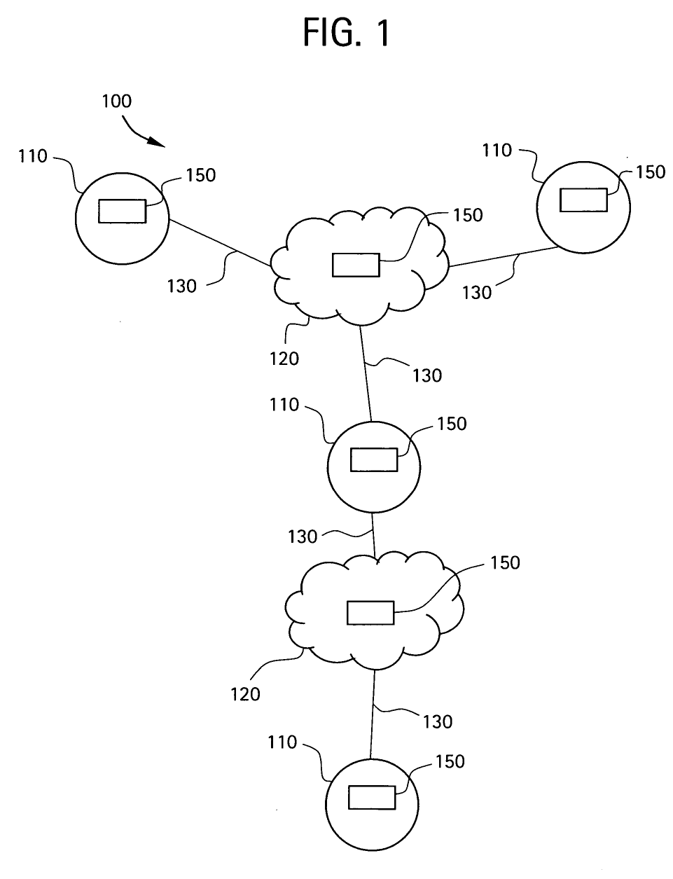

FIG. 1 illustrates a tactical communications network environment 100 operating with an embodiment of the presently described technology. The network environment 100 includes a plurality of communication nodes 110, one or more networks 120, one or more links 130 connecting the nodes and network(s), and one or more communication systems 150 facilitating communication over the components of the network environment 100. The following discussion assumes a network environment 100 including more than one network 120 and more than one link 130, but it should be understood that other environments are possible and anticipated.

Communication nodes 110 may be and/or include radios, transmitters, satellites, receivers, workstations, servers, and/or other computing or processing devices, for example.

Network(s) 120 may be hardware and/or software for transmitting data between nodes 110, for example. Network(s) 120 may include one or more nodes 110, for example.

Link(s) 130 may be wired and/or wireless connections to allow transmissions between nodes 110 and/or network(s) 120.

The communications system 150 may include software, firmware, and/or hardware used to facilitate data transmission among the nodes 110, networks 120, and links 130, for example. As illustrated in FIG. 1, communications system 150 may be implemented with respect to the nodes 110, network(s) 120, and/or links 130. In certain embodiments, every node 110 includes a communications system 150. In certain embodiments, one or more nodes 110 include a communications system 150. That is, in certain embodiments, one or more nodes 110 may not include a communications system 150.

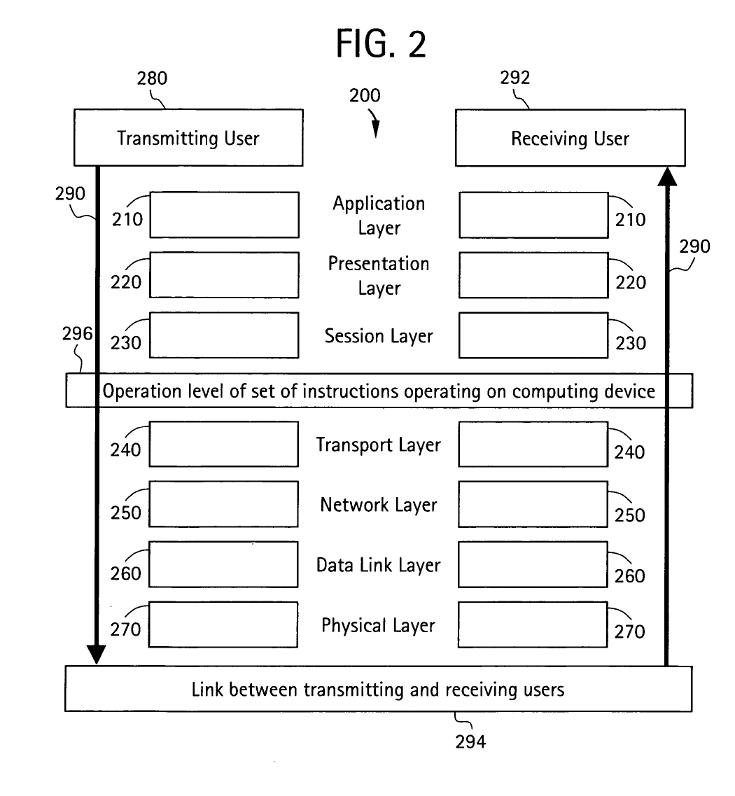

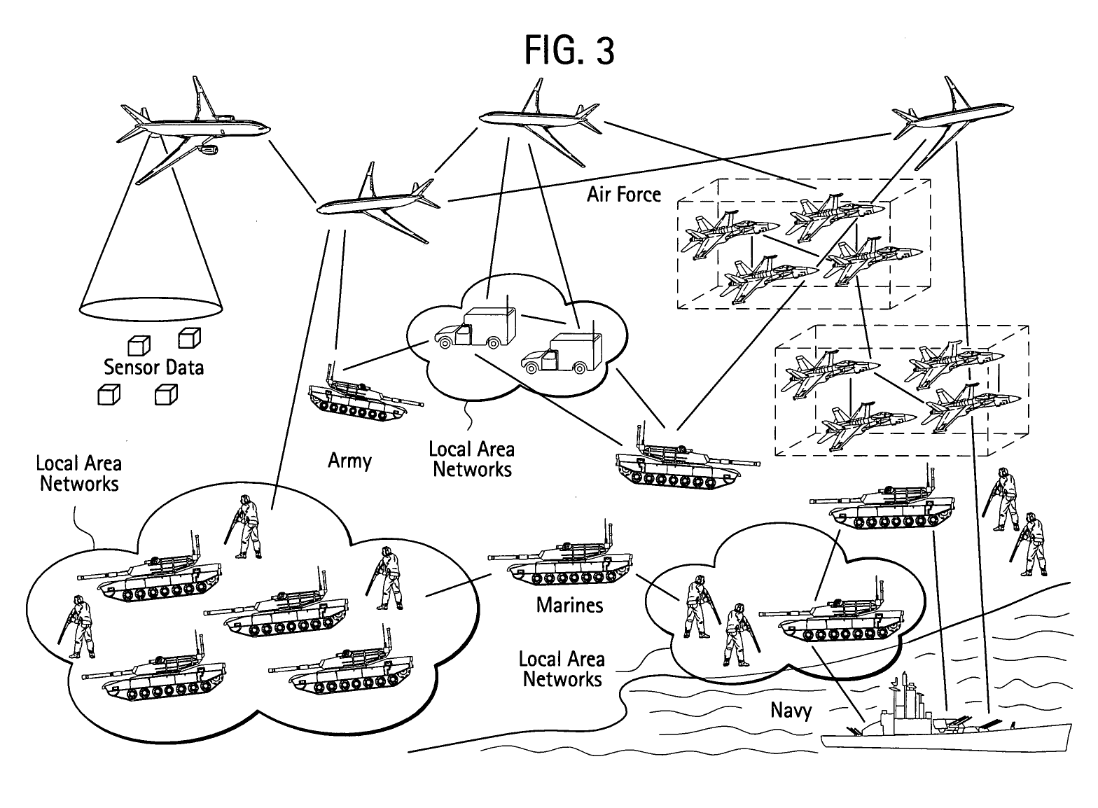

The communication system 150 provides dynamic management of data to help assure communications on a tactical communications network, such as the network environment 100. As shown in FIG. 2, in certain embodiments, the system 150 (or a set of instructions operating on a computer in system 150) operates as part of and/or at the top of the transport layer 240 in the OSI seven layer protocol model (described in more detail below). The system 150 may give precedence to higher priority data in the tactical network passed to the transport layer, for example. The system 150 may be used to facilitate communications in a single network, such as a LAN or wide area network (“WAN”), or across multiple networks. An example of a multiple network system is shown in FIG. 3. The system 150 may be used to manage available bandwidth rather than add additional bandwidth to the network, for example.

In certain embodiments, the system 150 is a software system, although the system 150 may include both hardware and software components in various embodiments. The system 150 may be network hardware independent, for example. That is, the system 150 may be adapted to function on a variety of hardware and software platforms. In certain embodiments, the system 150 operates on the edge of the network rather than on nodes in the interior of the network. However, the system 150 may operate in the interior of the network as well, such as at “choke points” in the network.

The system 150 can use rules and modes or profiles to perform throughput management functions such as optimizing available bandwidth, setting information priority, and managing data links in the network (for example, QoS parameters/mechanisms/algorithms). By “optimizing” bandwidth, it is meant that the presently described technology can be employed to increase an efficiency of bandwidth use to communicate data in one or more networks. Optimizing bandwidth usage can include removing functionally redundant messages, message stream management or sequencing, and message compression, for example. Setting information priority can include differentiating message types at a finer granularity than IP based techniques and sequencing messages onto a data stream via a selected rule-based sequencing algorithm, for example. Data link management can include rule-based analysis of network measurements to affect changes in rules, modes, and/or data transports, for example. A mode or profile can include a set of rules related to the operational needs for a particular network state of health or condition. The system 150 provides dynamic, “on-the-fly” reconfiguration of modes, including defining and switching to new modes on the fly.

The communication system 150 can be configured to accommodate changing priorities and grades of service, for example, in a volatile, bandwidth-limited network. The system 150 can be configured to manage information for improved data flow to help increase response capabilities in the network and reduce communications latency. Additionally, the system 150 can provide interoperability via a flexible architecture that is upgradeable and scalable to improve availability, survivability, and reliability of communications. The system 150 supports a data communications architecture that may be autonomously adaptable to dynamically changing environments while using predefined and predictable system resources and bandwidth, for example.

In certain embodiments, the system 150 provides throughput management to bandwidth-constrained tactical communications networks while remaining transparent to applications using the network. The system 150 provides throughput management across multiple users and environments at reduced complexity to the network. As mentioned above, in certain embodiments, the system 150 runs on a host node in and/or at the top of layer four (the transport layer) of the OSI seven layer model and does not require specialized network hardware. The system 150 may operate transparently to the layer four interface. That is, an application may utilize a standard interface for the transport layer and be unaware of the operation of the system 150. For example, when an application opens a socket, the system 150 may filter data at this point in the protocol stack. The system 150 achieves transparency by allowing applications to use, for example, the TCP/IP socket interface that is provided by an operating system at a communication device on the network rather than an interface specific to the system 150. System 150 rules may be written in extensible markup language (“XML”) and/or provided via custom dynamic link libraries (“DLL”), for example.

In certain embodiments, the system 150 provides QoS on the edge of the network. The system's QoS capability offers content-based, rule-based data prioritization on the edge of the network, for example. Prioritization can include differentiation and/or sequencing, for example. The system 150 can differentiate messages into queues based on user-configurable differentiation rules, for example. The messages are sequenced into a data stream in an order dictated by the user-configured sequencing rule (for example, starvation, round robin, relative frequency, etc.). Using QoS on the edge, data messages that are indistinguishable by traditional QoS approaches can be differentiated based on message content, for example. Rules can be implemented in XML, for example. In certain embodiments, to accommodate capabilities beyond XML and/or to support extremely low latency requirements, the system 150 allows dynamic link libraries to be provided with custom code, for example.

Inbound and/or outbound data on the network may be customized via the system 150. Prioritization protects client applications from high-volume, low-priority data, for example. The system 150 helps to ensure that applications receive data to support a particular operational scenario or constraint.

In certain embodiments, when a host is connected to a LAN that includes a router as an interface to a bandwidth-constrained tactical network, the system can operate in a configuration known as QoS by proxy. In this configuration, packets that are bound for the local LAN bypass the system and immediately go to the LAN. The system applies QoS on the edge of the network to packets bound for the bandwidth-constrained tactical link.

In certain embodiments, the system 150 offers dynamic support for multiple operational scenarios and/or network environments via commanded profile switching. A profile can include a name or other identifier that allows the user or system to change to the named profile. A profile may also include one or more identifiers, such as a functional redundancy rule identifier, a differentiation rule identifier, an archival interface identifier, a sequencing rule identifier, a pre-transmit interface identifier, a post-transmit interface identifier, a transport identifier, and/or other identifier, for example. A functional redundancy rule identifier specifies a rule that detects functional redundancy, such as from stale data or substantially similar data, for example. A differentiation rule identifier specifies a rule that differentiates messages into queues for processing, for example. An archival interface identifier specifies an interface to an archival system, for example. A sequencing rule identifier identifies a sequencing algorithm that controls samples of queue fronts and, therefore, the sequencing of the data on the data stream. A pre-transmit interface identifier specifies the interface for post-transmit processing, which provides for special processing such as encryption and compression, for example. A post-transmit interface identifier identifies an interface for post-transmit processing, which provides for processing such as de-encryption and decompression, for example. A transport identifier specifies a network interface for the selected transport.

A profile can also include other information, such as queue sizing information, for example. Queue sizing information identifiers a number of queues and amount of memory and secondary storage dedicated to each queue, for example.

In certain embodiments, the system 150 provides a rules-based approach for optimizing bandwidth. Again, by “optimizing” bandwidth, it is meant that the presently described technology can be employed to increase an efficiency of bandwidth use to communicate data in one or more networks. For example, the system 150 can employ queue selection rules to differentiate messages into message queues so that messages can be assigned a priority and an appropriate relative frequency on the data stream. The system 150 can use functional redundancy rules to manage functionally redundant messages. A message is functionally redundant if it is not different enough (as defined by the rule) from a previous message that has not yet been sent on the network, for example. That is, if a new message is provided that is not sufficiently different from an older message that has already been scheduled to be sent, but has not yet been sent, the newer message can be dropped, since the older message will carry functionally equivalent information and is further ahead in the queue. In addition, functional redundancy may include actual duplicate messages and newer messages that arrive before an older message has been sent. For example, a node can receive identical copies of a particular message due to characteristics of the underlying network, such as a message that was sent by two different paths for fault tolerance reasons. As another example, a new message can contain data that supersedes an older message that has not yet been sent. In this situation, the system 150 can drop the older message and send only the new message. The system 150 can also include priority sequencing rules to determine a priority-based message sequence of the data stream. Additionally, the system 150 can include transmission processing rules to provide pre-transmission and post-transmission special processing, such as compression and/or encryption.

In certain embodiments, the system 150 provides fault tolerance capability to help protect data integrity and reliability. For example, the system 150 can use user-defined queue selection rules to differentiate messages into queues. The queues are sized according to a user-defined configuration, for example. The configuration specifies a maximum amount of memory a queue can consume, for example. Additionally, the configuration can allow the user to specify a location and amount of secondary storage that may be used for queue overflow. After the memory in the queues is filled, messages can be queued in secondary storage. When the secondary storage is also full, the system 150 can remove the oldest message in the queue, logs an error message, and queues the newest message. If archiving is enabled for the operational mode, then the de-queued message can be archived with an indicator that the message was not sent on the network.

Memory and secondary storage for queues in the system 150 can be configured on a per-link basis for a specific application, for example. A longer time between periods of network availability may correspond to more memory and secondary storage to support network outages. The system 150 can be integrated with network modeling and simulation applications, for example, to help identify sizing to help ensure that queues are sized appropriately and time between outages is sufficient to help achieve steady-state and help avoid eventual queue overflow.

Furthermore, in certain embodiments, the system 150 offers the capability to meter inbound (“shaping”) and outbound (“policing”) data. Policing and shaping capabilities help address mismatches in timing in the network. Shaping helps to prevent network buffers form flooding with high-priority data queued up behind lower-priority data. Policing helps to prevent application data consumers from being overrun by low-priority data. Policing and shaping are governed by two parameters: effective link speed and link proportion. The system 150 may form a data stream that is no more than the effective link speed multiplied by the link proportion, for example. The parameters may be modified dynamically as the network changes. The system may also provide access to detected link speed to support application level decisions on data metering. Information provided by the system 150 may be combined with other network operations information to help decide what link speed is appropriate for a given network scenario.

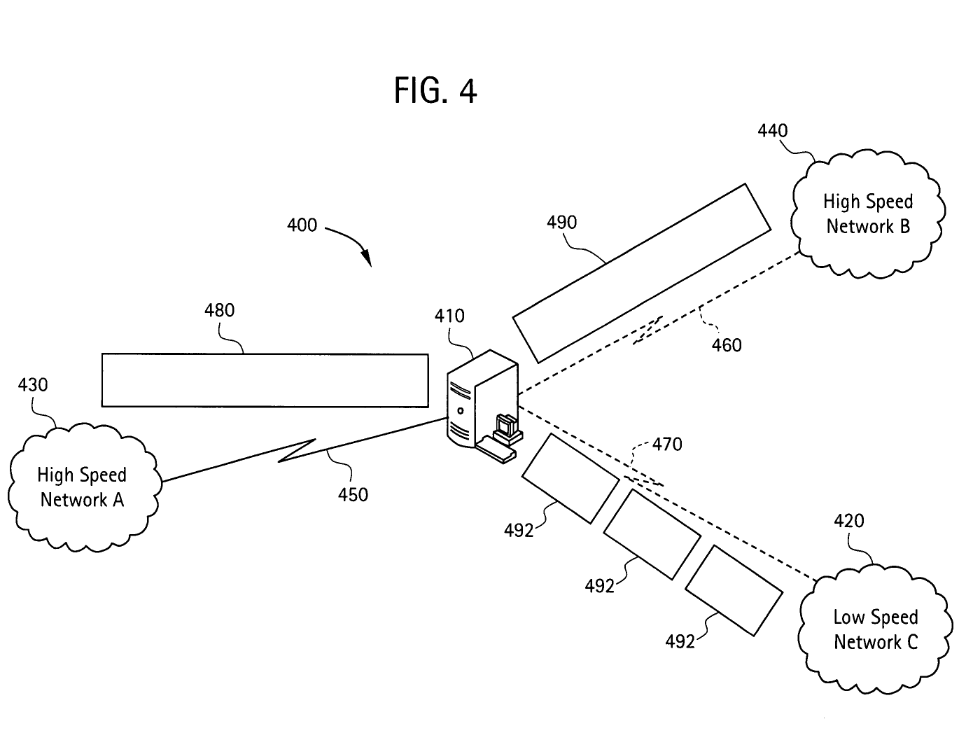

FIG. 4 illustrates a system 400 for selectively applying QoS algorithms by proxy to data transmitted to a network in accordance with an embodiment of the presently described technology. System 400 includes a computing device 410. Computing device 410 can be included in a communication system 150 of FIG. 1 described above, for example. Computing device 410 comprises any system, device, apparatus or group of systems, devices or apparatuses capable of performing electronic processing of data. For example, computing device 410 can comprise a personal computer, such as a desktop or laptop computer or a server computer.

In a preferred embodiment, computing device 410 is connected to a low speed network 420, a first high speed network 430 and a second high speed network 440. Device 410 can be located at the edge of a network, as described above. Device 410 performs QoS by proxy for low speed network 420, as described above and in more detail below.

The connections 450 and 460 between computing device 410 and first high speed network 430 and second high speed network 440 are high speed or large bandwidth connections. The connection 470 between computing device 410 and low speed network 420 is a low speed or small bandwidth connection. Connections 450, 460 and 470 can each include one or more of a wired or wireless connection or a combination of wired and wireless connections.

Low speed network 420 can include any network with a limited bandwidth capability or availability. For example, low speed network 420 can comprise a LAN such as a military tactical network. In a preferred embodiment, low speed network 420 is a tactical network such as a Tactical Satellite (“TACSAT”) network and a tactical HF network. In another example, low speed network 420 can include a radio or IP based radio network.

High speed networks 430, 440 can each include any network with a large bandwidth capability or availability. Generally, high speed networks 430, 440 have a greater bandwidth or throughput than low speed network 420. For example, each of high speed networks 430, 440 can comprise one or more networks with traditionally large bandwidth connections and high data throughputs. In a preferred embodiment, high speed networks 430, 440 is network comprising Ethernet connections and/or an EPLRS network.

In another embodiment, high speed networks 430, 440 are networks capable of communicating or transmitting data, such as IP packets, at a throughput of at least 100 times faster or greater than the throughput capability of low speed network 420. For example, high speed networks 430, 440 can each comprise an Ethernet network capable of transmitting or communicating data at a rate of 10 megabytes per second (“mbps”). In another example, high speed networks 430, 440 can each comprise a EPLRS network capable of transmitting or communicating data at a rate of 500 kbps. Conversely, low speed network 420 can comprise a TACSAT or HF network capable of transmitting or communicating data at a rate of 5 kbps.

Computing device 410 can include a computer-readable storage medium. For example, computing device 410 can include one or more computer hard drives, CD drives and/or DVD drives. The computer-readable storage medium is preferably local to computing device 410. In other words, the computer-readable storage medium is preferably located within computing device 410 or is physically connected or wired to computing device 410.

In another embodiment, the computer-readable storage medium is remote from computing device 410. In other words, computer-readable storage medium is located in a location other than the location where computing device 410 is located or is connected to computing device 410 over a wireless connection. For example, the computer-readable storage medium can be located on a computer server located away from computing device 410 but accessible to device 410 over a network connection.

The computer-readable storage medium comprises a set of instructions for operating computing device 410. Preferably, the set of instructions is embodied in one or more software applications capable of being run or executed on computing device 410. In a preferred embodiment, the set of instructions include one or more software routines for enabling computing device 410 to apply one or more QoS algorithms by proxy to data transmitted from first high speed network 430 to low speed network 420. In another embodiment, the set of instructions also allows computing device 410 to apply one or more QoS algorithms by proxy to data transmitted from first high speed network 430 to second high speed network 440.

The set of instructions for computing device 410 enable device 410 to provide dynamic management of data throughput for low speed network 420 before the data transmitted to low speed network 420 arrives at network 420. That is, device 410 can apply one or more QoS algorithms to data transmitted to network 420 without device 410 being hard-wired or fixed to network 420 and before the data arrives at network 420.

The QoS algorithm(s) can include any rule or parameter based adjustment of the priority or order in which data is transmitted to a given destination. In other words, a QoS algorithm can include one or more rules or parameters that give precedence to higher-priority data. In doing so, the QoS algorithm(s) can optimize bandwidth, establish or set priority on the information contained in the data, and manage a data link as bandwidth becomes constrained over a given data link or within a given network, as described above. Again, by “optimize” bandwidth, it is meant that the QoS algorithm(s) can be employed to increase an efficiency of bandwidth use to communicate data in one or more networks.

For example, optimizing bandwidth usage can include removing functionally redundant messages, message stream management or sequencing, and message compression, for example. Setting information priority can include differentiating message types at a finer granularity than IP based techniques and sequencing messages onto a data stream via a selected rule-based sequencing algorithm, for example. Data link management can include rule-based analysis of network measurements to affect changes in rules, modes, and/or data transports, for example.

The QoS parameters or algorithms can also include the prioritization of data based on user-configurable rules, as described above. For example, messages can be sequenced into a data stream in an order dictated by a user-configured sequencing rule (for example, starvation, round robin, relative frequency, etc.). Data messages that are indistinguishable by traditional QoS approaches can be differentiated based on message content, for example.

QoS algorithms can also be employed to manage a data link by dynamically modifying a link according to a selected mode. A mode comprises of a collection of rules and configuration information for controlling data propagation to and from the transport layer on a network link. The mode can specify throughput management rules, archival configuration, pre- and post-transmission rules, and transport selection.

The set of instructions operate at the top of the transport layer of the OSI seven-layer model. FIG. 2 illustrates a schematic diagram of the OSI seven-layer model 200 (described above) and the operation of the set of instructions for computing device 410 in accordance with an embodiment of the presently described technology. The OSI model 200 includes seven layers, namely an application layer 210, a presentation layer 220, a session layer 230, a transport layer 240, a network layer 250, a data link layer 260 and a physical layer 270. A transmitting user 280 communicates data 290 to a receiving user 292 over a link 294.

In accordance with the presently described technology, the set of instructions operating on computing device 410 implements one or more QoS algorithms at a level 296 above transport layer 240 of OSI model 200. In doing so, the sets of instruction are able to optimize the bandwidth available to low speed network 420 while providing the network independence of the presently described technology. Again, by “optimize” bandwidth, it is meant that the QoS algorithm(s) can be employed to increase an efficiency of bandwidth use to communicate data in one or more networks. In other words, traditional QoS solutions are network specific with a different configuration of QoS solutions for each network type. However, according to the presently described technology, computing device 410 is able to apply QoS algorithms to data transmitted to low speed network 420 without being “hard-wired” or confined to the hardware of network 420. In addition, computing device 410 is also able to apply QoS algorithms to data transmitted to low speed network 420 by proxy—that is, without being a node or switch confined to network 420 that applies QoS algorithms to data within network 420. In doing so, computing device 410 can be connected to a number of different networks (high speed and/or low speed) and apply various QoS algorithms by proxy to the various networks.

In a preferred embodiment, the set of instructions for computing device 410 includes at least two routines—a data destination routine and a QoS algorithm application routine (“application routine”). However, the set of instructions can include a single routine or a larger number of routines in accordance with the presently described technology.

In a preferred embodiment, the set of instructions are written in standard Extensible Markup Language (“XML”). In another embodiment, the set of instructions are provided to computing device 410 via customized dynamic link libraries (“DLL”). The use of customized DLLs can be preferred to XML where extremely low latency requirements must be supported.

The set of instructions can filter data at the top of the protocol stack when an application opens a network socket to transmit data. The set of instructions can be transparent to users as the instructions use the TCP/IP socket interface provided by the operating system of device 410.

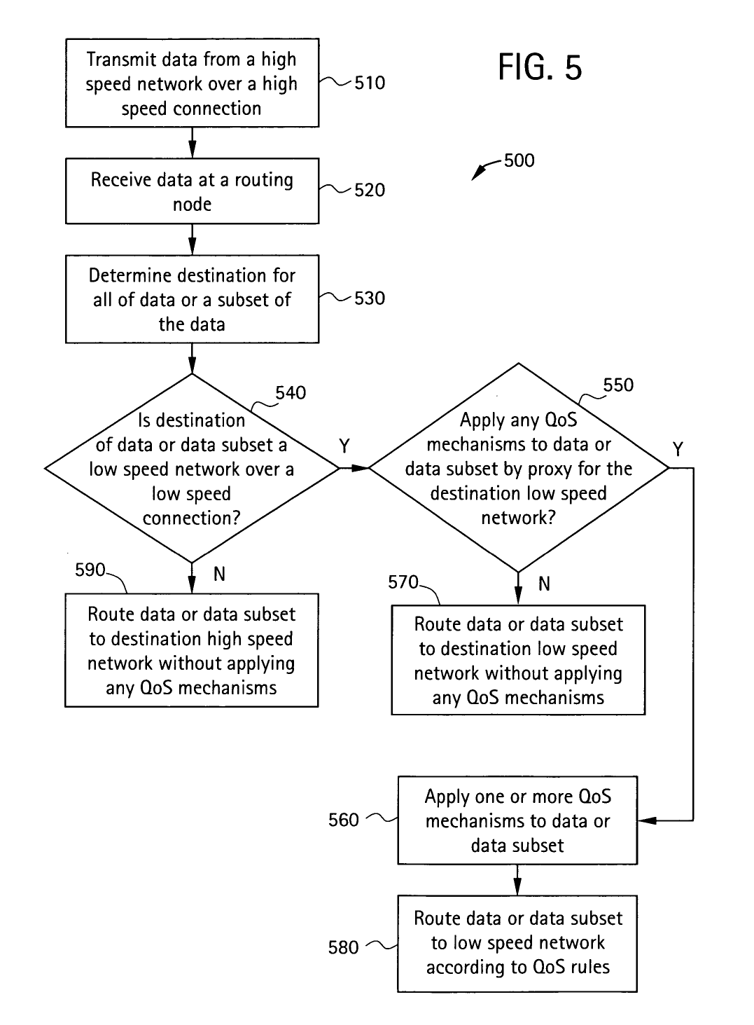

In a preferred embodiment, the set of instructions selectively apply QoS algorithm(s) according to a method 500. FIG. 5 illustrates a flowchart of method 500 for selectively applying QoS algorithms by proxy to data transmitted to a network in accordance with an embodiment of the presently described technology.

According to method 500, first at step 510, data 480 or “high speed” data 480 is transmitted from first high speed network 430 over a high speed network connection 450. Next, at step 520, data 480 is received at a routing node, such as computing device 410. At step 530, the data destination routine (of the sets of instructions operating on computing device 410) determines a destination for all of data 480 or a subset of data 480. The destination can be determined by examining an IP destination address of data 480, for example.

At step 540, the application routine determines if the destination of data 480 or a subset of data 480 is a low speed network. For example, the application routine determines if the intended or predetermined destination of data 480 is low speed network 420. If it is determined at step 540 that the destination is low speed network 420, method 500 proceeds to step 550.

In another embodiment of the presently described technology, at step 540 the application routine determines if the destination of data 480 or a subset of data 480 is a network that requires the transmission of data 480 or a subset of data 480 over a low speed connection. For example, the application routine determines if the destination a network requiring transmission over low speed connection 470. If it is determined at step 540 that the destination requires transmission over low speed connection 470, method 500 proceeds to step 550.

At step 550, the application routine determines if computing device is to apply one or more QoS algorithms to data 480 or subset of data 480 for low speed network 420. The application routine determines if a QoS algorithm is to be applied based on one or more of the QoS rule or parameters described above. If application routine determines that one or more QoS algorithms is to be applied to data 480 or a subset of data 480, then method 500 proceeds to step 560.

At step 560, the application routine applies the QoS algorithm(s) to data 480 or subset of data 480. The exact QoS algorithm(s) that are applied can be determined by a selected profile or mode, as described in the applications referred to above. By applying the QoS algorithm(s), a priority order of one or more subsets of data 480, or of one or more data packets of data 480, is established. After applying the QoS algorithm(s), method 500 proceeds to step 580.

At step 580, data 480 or subset of data 480 to which the QoS algorithm(s) was applied is routed or transmitted according to the QoS algorithm(s) as data 492 or “low speed” data 492 to low speed network 420. Data 492 can be routed or transmitted along a low speed connection 470. If the QoS algorithm(s) dictate that all of data 480 is to be routed to low speed network 420, then all of data 480 is sent as data 492 according to the QoS algorithm(s). If only a subset of data 480 is to be routed to low speed network 420 after one or more QoS algorithms are applied, then the subset of data 480 to which the algorithm(s) were applied is sent as data 492 according to the QoS algorithm(s).

By applying the QoS algorithm(s) to all or a subset of data 480, other data or another subset of data 480 can receive a higher or lower priority and be transmitted to a receiving node at low speed network 420 accordingly. For example, if a first subset of data 480 receives a higher priority than a second subset of data 480 at step 560, at step 580, the first subset of data 480 is transmitted to a receiving node in low speed network 420 before the second subset of data 480. In another example, by applying QoS algorithm(s) to a plurality of data 480 subsets at step 560, a priority order of data 480 subsets is established. The data 480 subsets can then be transmitted to a predetermined destination node(s) at low speed network 420 according to the priority order at step 580.

If at step 550 it is determined that no QoS algorithms are to be applied to data 480 or a subset of data 480 by the application routine, then method 500 proceeds from step 550 to step 570. At step 570, computing device 410 routes data 480 or data 480 subset to low speed network 420 without applying any QoS algorithms.

If at step 540 it is determined that the destination of data 480 or data 480 subset is second high speed network 440, then method 500 proceeds from step 540 to step 590. At step 590, data 480 or subset of data 480 that is intended for second high speed network 440 is sent as data 490 or “high speed” data 490 to second high speed network 440. Data 490 can be transmitted over a high speed connection 460, for example.

Method 500 therefore provides a method for selectively applying one or more QoS algorithms to data transmitted from a large bandwidth network (first high speed network 430) to a low speed network (network 420). As described above, when data is streamed from a large bandwidth network and routed to other large and small bandwidth networks, the smaller bandwidth networks can be overrun with data. The smaller bandwidth networks can be overrun because, in part, the destination nodes on smaller bandwidth networks may not be capable of handling large amounts of data. In accordance with the presently described technology, to accommodate the smaller bandwidth networks, a routing node (such as computing device 410) can selectively apply QoS algorithms to data destined only for smaller bandwidth networks (such as low speed network 420). In addition, the routing node is able to apply QoS algorithms to the smaller bandwidth networks by proxy, as the routing node applies the QoS algorithms to data before it arrives at the smaller bandwidth network.

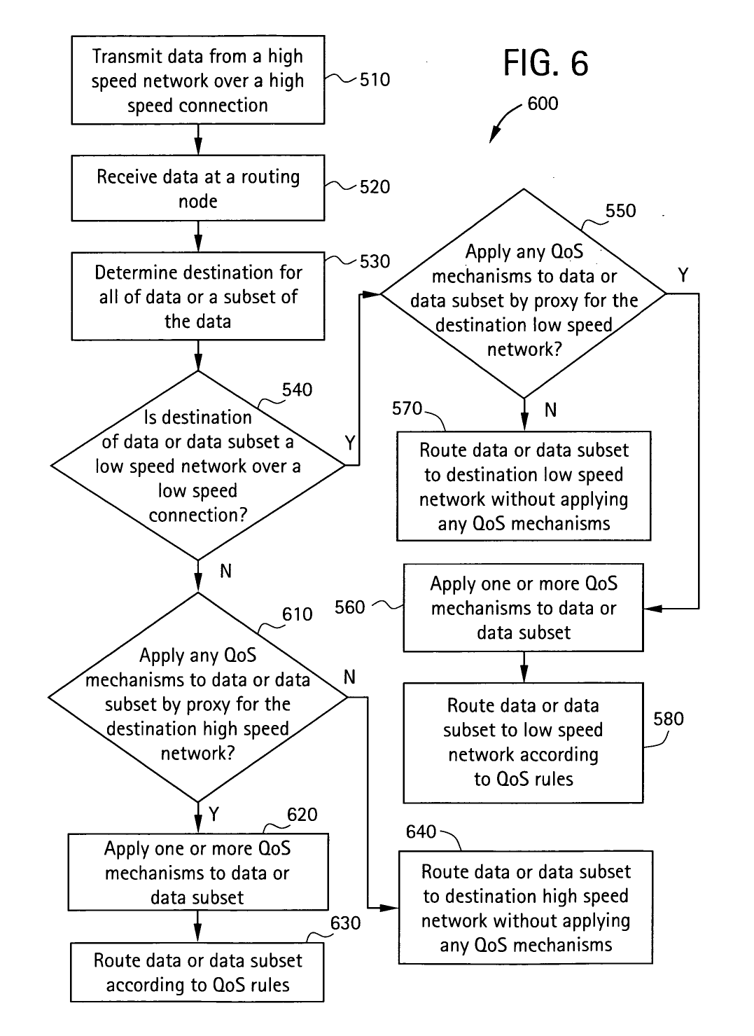

In another embodiment of the presently described technology, computing device 410 can also be used to selectively apply, by proxy, one or more QoS algorithms to data transmitted from one high speed network to another. Similar to the selective application of QoS algorithms to data 480 transmitted from first high speed network 430 to low speed network 420, the set of instructions operating on computing device 410 can also be used to selectively apply QoS algorithms to data 480 transmitted from first high speed network 430 to second high speed network 440. FIG. 6 illustrates a flowchart of method 600 for selectively applying QoS algorithms by proxy to data transmitted from one high speed network to another in accordance with an embodiment of the presently described technology. Method 600 includes several similar steps as method 500, as discussed above. Specifically, method 500 and method 600 have the following steps in common: steps 510, 520, 530, 540, 550, 560, 570 and 580.

With regard to method 600, if at step 540 it is determined that the destination of data 480 or subset of data 480 is second high speed network 440, method 600 proceeds from step 540 to step 610. At step 610, application routine determines whether one or more QoS algorithms are to be applied to data 480 or a subset of data 480 for second high speed network 440. If one or more QoS algorithms are to be applied, method 600 proceeds from step 610 to step 620.

At step 620, the application routine applies the QoS algorithm(s) to data 480 or subset of data 480. As described above, the exact QoS algorithm(s) that are applied can be determined by a selected profile or mode, as described above. After applying the QoS algorithm(s), method 600 proceeds to step 630.

At step 630, data 480 or subset of data 480 to which the QoS algorithm(s) was applied is routed or transmitted according to the QoS algorithm(s) as data 490 to second high speed network 440. Data 490 can be routed or transmitted along a high speed connection 460. If the QoS algorithm(s) dictate that all of data 480 is to be routed to second high speed network 440, then all of data 480 is sent as data 490 according to the QoS algorithm(s). If only a subset of data 480 is to be routed to second high speed network 440 after one or more QoS algorithms are applied, then the subset of data 480 to which the algorithm(s) were applied is sent as data 490 according to the QoS algorithm(s).

If at step 610 it is determined that no QoS algorithms are to be applied to data 480 or a subset of data 480 by the application routine, then method 600 proceeds from step 610 to step 640. At step 640, computing device 410 routes data 480 or data 480 subset to second high speed network 440 without applying any QoS algorithms.

While particular elements, embodiments and applications of the presently described technology have been shown and described, it is understood that the presently described technology is not limited thereto since modifications may be made by those skilled in the technology, particularly in light of the foregoing teaching. It is therefore contemplated by the appended claims to cover such modifications and incorporate those features that come within the spirit and scope of the presently described technology.

What is claimed is:

1. A method for selectively applying one or more Quality of Service (“QoS”) algorithms comprising:
receiving data transmitted to a node at a predetermined destination in at least one of a first network and a second network; and
applying at least one of said QoS algorithms to said data based on said destination.

2. The method of claim 1, wherein said applying step comprises applying at said at least one QoS algorithm to said data so that a subset of said data is received at said destination before at least one other subset of said data is received at said destination.

3. The method of claim 1, wherein said applying step comprises applying said at least one QoS algorithm only if said destination is in said second network.

4. The method of claim 3, further comprising routing said data to said destination at said first network without applying any of said QoS algorithms to said data if said destination is in said first network.

5. The method of claim 3, wherein said first network is a high speed network and said second network is a low speed network.

6. The method of claim 5, wherein said high speed network is a network capable of communicating data at a rate at least 100 times faster than said low speed network.

7. The method of claim 1, wherein said data is transmitted from a high speed network.

8. A computer-readable storage medium comprising a set of instructions for a computer, said instructions comprising:
a data destination routine configured to determine an intended destination of data received at a routing node; and
an application routine configured to apply at least one QoS algorithm to at least a subset of said data, said algorithm based on said destination.

9. The set of instructions of claim 8, wherein said application routine applies said at least one QoS algorithm to said data so that a subset of said data is received at said destination before at least one other subset of said data is received at said destination.

10. The set of instructions of claim 8, wherein said application routine does not apply said at least one QoS algorithm if said destination is a node located in a first network and said application routine does apply said at least one QoS algorithm if said destination is a node located in a second network.

11. The set of instructions of claim 10, wherein said first network is a high speed network and said second network is a low speed network.

12. The set of instructions of claim 11, wherein said high speed network is a network capable of communicating data at a rate at least 100 times faster than said low speed network.

13. The set of instructions of claim 8, wherein said data is transmitted from a high speed network.

14. A method for applying a Quality of Service (“QoS”) algorithm to a network by proxy, said method comprising:
receiving said data at a routing node;
determining an intended destination of a first data subset of said data in a high speed network and an intended destination of a second data subset of said data in a low speed network;
routing said first data subset to said intended destination of said first data subset in said high speed network without applying said QoS algorithm to said first data subset;
applying said QoS algorithm to said second data subset; and
routing said second data subset to said intended destination of said second data subset in said low speed network.

15. The method of claim 14, further comprising transmitting said first and second data subsets from a second high speed network.

16. The method of claim 14, further comprising connecting said routing node to said low speed network.

17. The method of claim 14, wherein said applying step changes a priority order in which one or more data packets in said second data subset are transmitted to said intended destination in said low speed network during said routing step.

18. The method of claim 14, wherein each of said first and second high speed networks are capable of transmitting data at a rate at least 100 times faster than said low speed network.

19. The method of claim 14, wherein said low speed network is a Local Area Network (“LAN”) in a military tactical network.

20. The method of claim 14, wherein said connecting step comprises connecting said routing node to said low speed network over a radio link.
